(19) United States
(12) Patent Application Publication
(10) Pub. No.: US 2013/0088420 A1
(43) Pub. Date: Apr. 11, 2013

(54) METHOD AND APPARATUS FOR DISPLAYING IMAGE BASED ON USER LOCATION

(71) Applicant: Seong Min KANG, Seoul (KR)

(72) Inventor: Seong Min KANG, Seoul (KR)

(73) Assignee: SAMSUNG ELECTRONICS CO. LTD., Suwon-si (KR)

(21) Appl. No.: 13/541,087

(22) Filed: Jul. 3, 2012

(30) Foreign Application Priority Data
Oct. 10, 2011 (KR) 10-2011-0102845

(51) Int. Cl. G06F 3/01

(52) U.S. Cl. 345/156

(57) ABSTRACT

A method and an apparatus for displaying an image based on a user location allowing a user to view a displayed image similar to original image although viewing it from any location are provided. The method includes receiving a location value indicating a location of a user while displaying an original image, transforming the original image based on the received location value, and displaying the transformed image.

### PRIORITY

This application claims the benefit under 35 U.S.C. §119(a) of a Korean patent application filed on Oct. 10, 2011 in the Korean Intellectual Property Office and assigned Serial No. 10-2011-0102845, the entire disclosure of which is hereby incorporated by reference.

### BACKGROUND OF THE INVENTION

1. Field of the Invention

The present invention relates to a method and an apparatus for displaying an image based on a user location. More particularly, the present invention relates to a method for displaying an image based on a user location allowing a user to view a displayed image similar to original image although viewing it from any location and an apparatus thereof.

2. Description of the Related Art

Display devices employ various technologies, including Liquid Crystal Display (LCD), Organic Light Emitting Diode (OLED), and Active Matrix Organic Light Emitting Diode (AMOLED). In recent years, demand for a three-dimensional (3D) stereo image has increased. Research into a stereoscopic image in a field such as TVs and 3D information terminals has been actively performed. However, an image may be distorted depending on a location of a user, such as the user's viewing angle. Because objects farther from the user appear smaller than objects closer to the user, when a user views an image in a location other than a front of a screen, the image appears distorted.

### SUMMARY OF THE INVENTION

Aspects of the present invention are to address at least the above-mentioned problems and/or disadvantages and to provide at least the advantages described below. Accordingly, an aspect of the present invention is to provide a method for displaying an image based on a user location as the user views an original image in a front surface in any locations by compensating for a difference of a depth feeling according to the user location.

In accordance with an aspect of the present invention, a method for displaying an image is provided. The method includes receiving a location value indicating a location of a user while displaying an original image, transforming the original image based on the received location value, and displaying the transformed image.

In accordance with another aspect of the present invention, an apparatus for displaying an image is provided. The apparatus includes a sensor for sensing information associated with a location of a user, a controller for calculating a location value identifying the location of the user based on sensing information received from the sensor, and for transforming the original image based on the calculated location value, and a display unit for displaying the transformed image received from the controller.

In accordance with another aspect of the present invention, a method for displaying an image is provided. The method includes displaying an original image, calculating a location and viewing angle of a user viewing the image, determining whether the user is located in front of the monitor such that the original image would not appear distorted to the user, based on the calculated location and viewing angle, and when the user is not located in front of the monitor such that the original image would appear distorted to the user, identifying a changed amount of a vanishing point based on the calculated location and viewing angle, moving the vanishing point of the original image based on the changed amount, transforming the image based on the moved vanishing point, and displaying the transformed image.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1A-1D are views illustrating imbalance of an image according to a viewing angle according to an exemplary embodiment of the present invention;

FIGS. 2A-2C are views according to an exemplary embodiment of the present invention;

FIGS. 3A-3C are views according to an exemplary embodiment of the present invention;

FIGS. 4A-4C are views according to an exemplary embodiment of the present invention;

FIGS. 5A-5D are views according to an exemplary embodiment of the present invention;

FIGS. 6A-6D are views according to an exemplary embodiment of the present invention;

FIGS. 7A-7D are views according to an exemplary embodiment of the present invention;

FIGS. 8A-8C are views according to an exemplary embodiment of the present invention;

FIGS. 9A-9C are views according to an exemplary embodiment of the present invention;

FIG. 10 is a three-dimensional coordinate system for expressing a location of a user according to an exemplary embodiment of the present invention;

FIG. 11 is a block diagram illustrating an apparatus for displaying an image according to an exemplary embodiment of the present invention;

FIGS. 12A and 12B are views illustrating an angle system for expressing a viewing angle of the user according to an exemplary embodiment of the present invention;

FIG. 13 is a block diagram illustrating an apparatus for displaying an image according to an exemplary embodiment of the present invention;

FIG. 14 is a block diagram illustrating an apparatus for displaying an image according to an exemplary embodiment of the present invention;

FIG. 15 is a block diagram illustrating an apparatus for displaying an image according to an exemplary embodiment of the present invention;

FIG. 16 is a flowchart illustrating a method for displaying an image according to an exemplary embodiment of the present invention; and

FIG. 17 is a flowchart illustrating a method for displaying an image according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

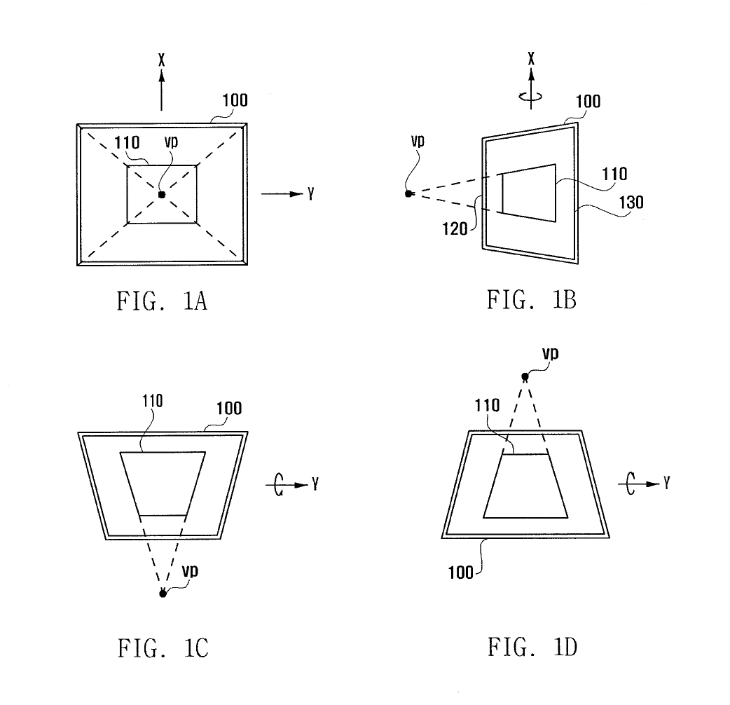

FIGS. 1A-1D are views illustrating imbalance of an image according to a viewing angle according to an exemplary embodiment of the present invention.

Referring to FIGS. 1A-1D, the image 110 is viewed differently according to a location in which the user views a monitor 100. That is why a vanishing point changes according to a viewing angle with the monitor 100. As shown in FIG. 1A, when viewing the monitor 100 in the front, the user may view an original image 110. However, as shown in FIG. 1B, when the monitor 100 is rotated in a clockwise direction around an X axis, a left side 120 of the monitor 100 becomes further away than a right side 130. Accordingly, the left part of the image 110 appears smaller than the right part. As a vanishing point VP moves from a center of the monitor 100 to the left, the image appears to the viewer to transform. In the same manner, as shown in FIG. 1C, when the monitor 100 is rotated in a counterclockwise direction around a Y axis, an upper part of the image 100 appears larger than a lower end. In addition, as shown in FIG. 1D, when the monitor 100 is rotated in a clockwise direction around the Y axis, an upper end of the image 100 appears smaller than a lower end.

According to exemplary embodiments of the present invention, an original image appears to user regardless of a viewing angle by transforming an image in consideration of a change in the vanishing point.

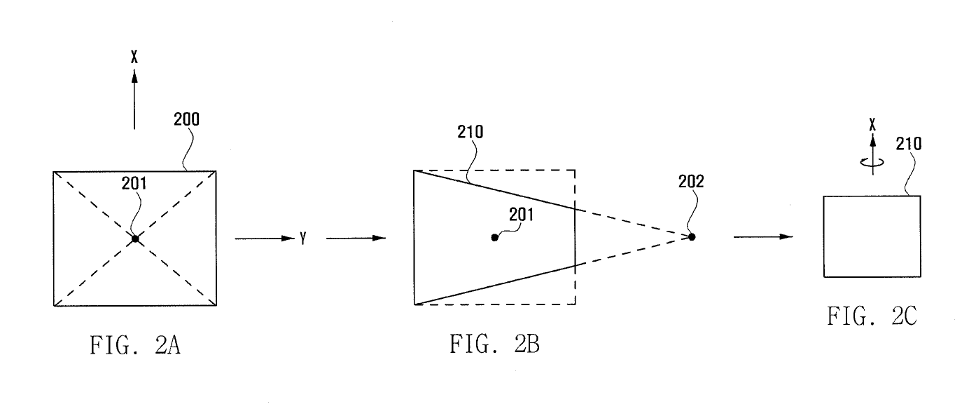

FIGS. 2A-2C, 3A-3C, and 4A-4C are views illustrating exemplary embodiments of the present invention.

Referring to FIGS. 2A-2C, an apparatus for displaying an image according to an exemplary embodiment of the present invention moves a vanishing point of an original image 200 from a center 201 of the original image 200 to a location 202 distant along a horizontal axis (Y axis) in the right direction by a predetermined distance. The apparatus transforms the original image 200 based on the moved vanishing point. As shown in FIG. 2B, the apparatus transforms a part of the image 200 closer to the vanishing point to be smaller. If the transformed image 210 is rotated in a clockwise direction (namely, opposite to a moving direction of the vanishing point), a right part of the transformed image 210 appears larger than a left part thereof.

As shown in FIG. 2C, the lengths of a right part and a left part of the transformed image are equally viewed in a certain horizontal rotation angle. The user may view an image with a ratio similar to that of the original image in the horizontal rotation angle. The apparatus may create a table where a changed amount of a vanishing point and the horizontal rotation angle match each other and store the table in a storage unit. When a monitor is rotated in a clockwise direction by the horizontal rotation angle around an X axis, or a viewing angle of a user with the monitor is the horizontal rotation angle around an X axis, a changed amount of the vanishing point matching the horizontal rotation angle is confirmed from the table, and the vanishing point is moved by the confirmed changed amount of the vanishing point to transform an original image.

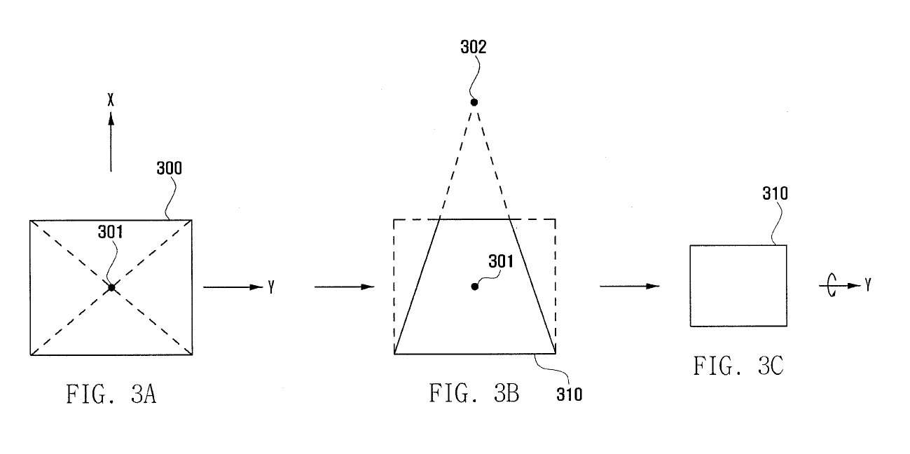

Referring to FIGS. 3A-3C, the apparatus moves a vanishing point of the original image 300 from a center 301 of the image to a location 302 distant along an X axis upward by a predetermined distance. As shown in FIG. 3B, the apparatus transforms a part of the original image 200 closer to the vanishing point to be smaller. If the transformed image 310 is rotated in a counterclockwise direction around a Y axis, an upper end of the transformed image 310 appears gradually larger than a lower end thereof. Accordingly, as shown in FIG. 3C, the lengths of the upper end and the lower end of the transformed image 310 are equally viewed in a certain vertical rotation angle. The apparatus may match the vertical rotation angle with a changed amount of a vanishing point and store the matched result in a table.

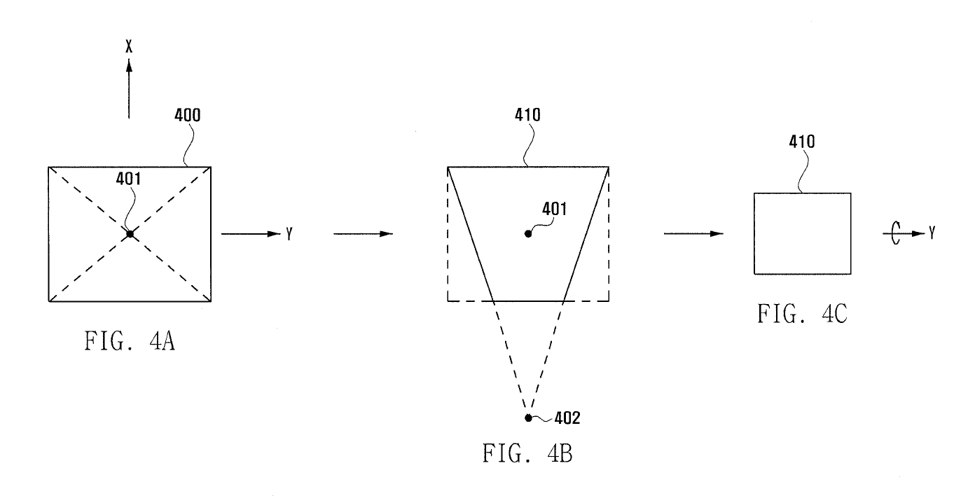

Referring to FIGS. 4A-4C, the apparatus moves the vanishing point of an original image 400 from a center 401 of the image to a location 402 along an X axis downward by a predetermined distance. As shown in FIG. 4B, the apparatus transforms a part of the original image 400 closer to the vanishing point. If the transformed image 410 is rotated in a clockwise direction around a Y axis, an upper end of the transformed image 410 appears gradually smaller than a lower end thereof. Accordingly, the lengths of the upper end and the lower end of the transformed image 410 are equally viewed in a certain vertical rotation angle. The apparatus may match the vertical rotation angle with a changed amount of a vanishing point and store the matched result in a table.

A method for creating the table may include transforming an original image based on a changed amount of a vanishing point, rotating a monitor of the apparatus, receiving a matching event, determining a viewing angle of a user when the matching event is received, matching the viewing angle with the changed amount of the vanishing point, automatically matching viewing angles with changed amounts of another vanishing point based on the two matched values to create a vanishing point conversion table, and storing the vanishing point conversion table in a storage unit.

As illustrated above, according to an exemplary embodiment of the present invention, a user appears to view an original image in the front regardless of an angle which the user actually views the monitor. However, an issue may arise in which an aspect ratio is transformed differently from an origin according to a viewing angle. For example, if an aspect ratio of the original image is a rectangle of “2:1”, when viewing a transformed image at a certain rotation angle according to the present invention, the user may view it as a square having different aspect ratio of “3:2”. An approach for addressing such an issue is described below.

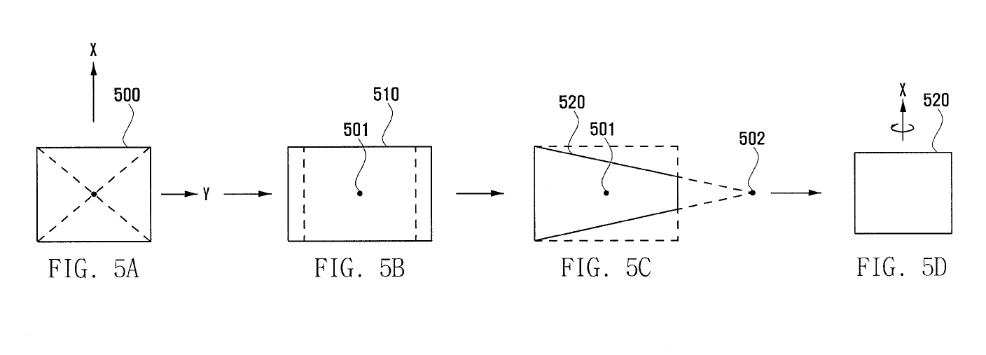

FIGS. 5A-5D, 6A-6D, and 7A-7D are views illustrating another exemplary embodiment of the present invention. An issue where an aspect ratio is viewed to be transformed may be solved by changing an aspect ratio of the original image before converting a vanishing point.

Referring to FIGS. 5A-5D, an apparatus for displaying an image according to an exemplary embodiment of the present invention changes an aspect ratio of the original image 500. For example, as shown in FIGS. 5A and 5B, the apparatus transforms an original image 500 of a square having an aspect ratio of “1:1” to an image 510 of a rectangle extending a transverse length. The apparatus moves a vanishing point from a center 501 of the transformed image 510 to a location 502 distant along a transverse axis (Y axis) in a right direction by a predetermined distance. As shown in FIG. 5C, the apparatus again transforms the image based on the moved vanishing point. When the transformed image 520 is rotated in a clockwise direction around a vertical axis (X axis), the user may view an image having the same aspect ratio as that of the origin in a certain horizontal rotation angle.

The apparatus may create an aspect ratio conversion table in which a horizontal rotation angle matches a changed amount of a transverse ratio and store the aspect ratio conversion table in a storage unit. The apparatus may also create a vanishing ratio conversion table in which a horizontal rotation angle matches a changed amount of a vanishing point and store the vanishing point conversion table in a storage unit. Accordingly, when a monitor is rotated in a clockwise direction by the horizontal rotation angle around an X axis or a viewing angle of a user with the monitor is the horizontal rotation angle around the X axis, the apparatus confirms an aspect ratio change amount and a changed amount of a vanishing point matching the horizontal rotation angle from respective angles, changes an aspect ratio of the original image by the confirmed aspect ratio change amount, and moves the vanishing point by the confirmed changed amount of a vanishing point to again transform the transformed image. The apparatus may reduce a vertical length instead of a transverse length of the original image 500 to change an aspect ratio. In this case, although change in an aspect ratio of the transformed image is reduced in comparison with that in the transformed image, a total size the transformed image may appear smaller.

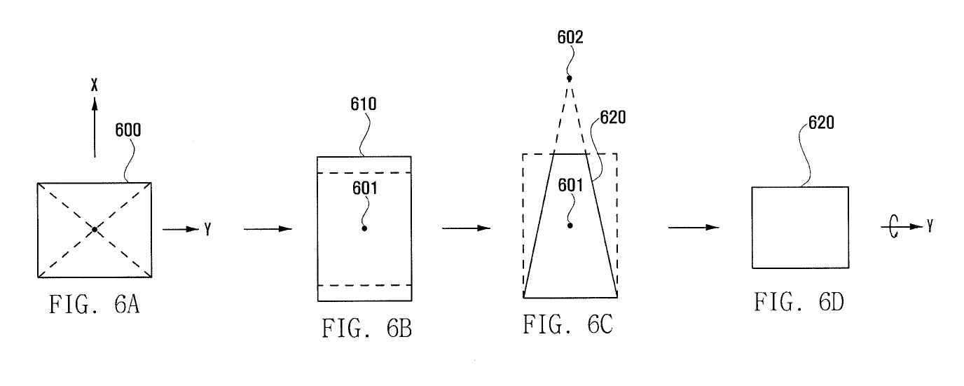

Referring to FIGS. 6A-6D, the apparatus transforms an original image 600 to an image 610 by extending a vertical length as shown in FIGS. 6A and 6B. The apparatus moves a vanishing point from a center 601 of the transformed image 610 to a location 602 distant along an X axis upward by a predetermined distance. As shown in FIG. 6C, the apparatus again transforms the image 610 based on the moved vanishing point. When the transformed image 620 is rotated in a counterclockwise direction around a Y axis, the user may view an image having the same aspect ratio as that of the origin in a certain vertical rotation angle as shown in FIG. 6D.

The apparatus may create an aspect ratio conversion table in which a changed amount of a vertical ratio matches a vertical rotation angel and store the aspect ratio conversion table in a storage unit. The apparatus may also create a vanishing point conversion table in which a vertical rotation angle matches a changed amount of a vanishing point in an X direction and store the vanishing point conversion table in a storage unit. The apparatus may reduce a transverse length of an original image 500 instead of a vertical length thereof to change an aspect ratio.

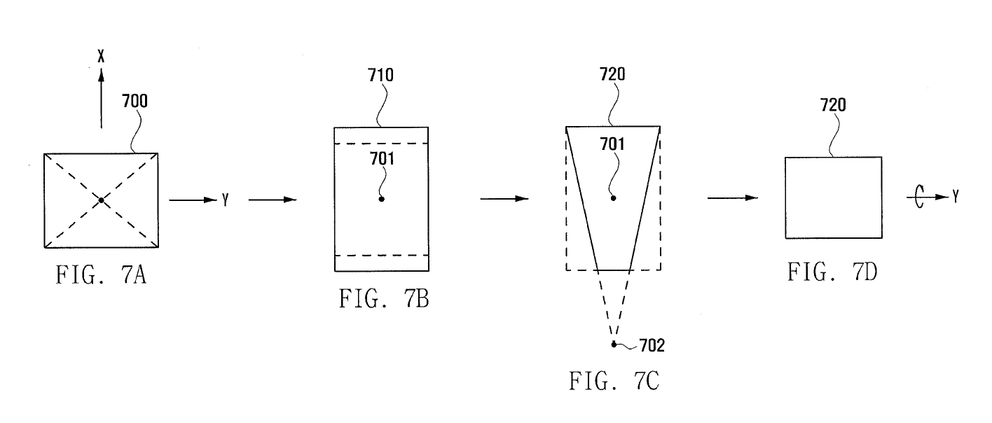

Referring to FIGS. 7A-7D, when an image is rotated in a clockwise direction around a Y axis, the apparatus allows a user to view an image having the same aspect ratio as that of the original image in a certain vertical rotation angle. Reference numeral 700 denote an original image in FIG. 7A. Reference numerals 710 and 701 denote a transformed image in which an aspect ratio is changed from the original image 700 and a center thereof, respectively. Reference numerals 702 and 720 denote a location of a vanishing point moved downward along an X axis and a transformed image based on the moved location 702 of the vanishing point.

In the foregoing exemplary embodiments of the present invention, an entire displayed screen is transformed. According to another embodiment of the present invention, a certain image, or an image portion, of a displayed screen may be transformed. Only a certain image may be viewed similar to a ratio of an original image, regardless of a viewing angle, while other images may be unchanged. The certain image (or image portion) may omit a background.

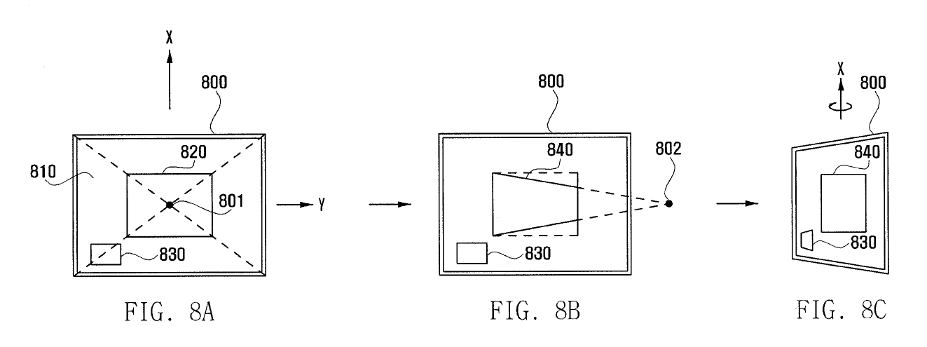

FIGS. 8A-8C are views according to another exemplary embodiment of the present invention.

Referring to FIGS. 8A-8C, the apparatus moves a vanishing point of a screen 810 of a monitor 800 from a center 801 of a screen to a location 802 distant along the X axis in a right direction by a predetermined distance as shown in FIGS. 8A and 8B. The apparatus transforms only a first image 820 on a screen 810 based on the moved vanishing point. When the monitor 810 is rotated in a clockwise direction around the X axis, the transformed image 840 is viewed similar to a ratio in the original image, but a second image 830 appears distorted. The apparatus may change an aspect ratio before transforming the first image 820.

Exemplary embodiments of the present invention are applicable to 3D display technology. The apparatus for displaying an image according an exemplary embodiment of the present invention may make a right eye image and a left eye image to be viewed similar to the original image regardless of a viewing angle.

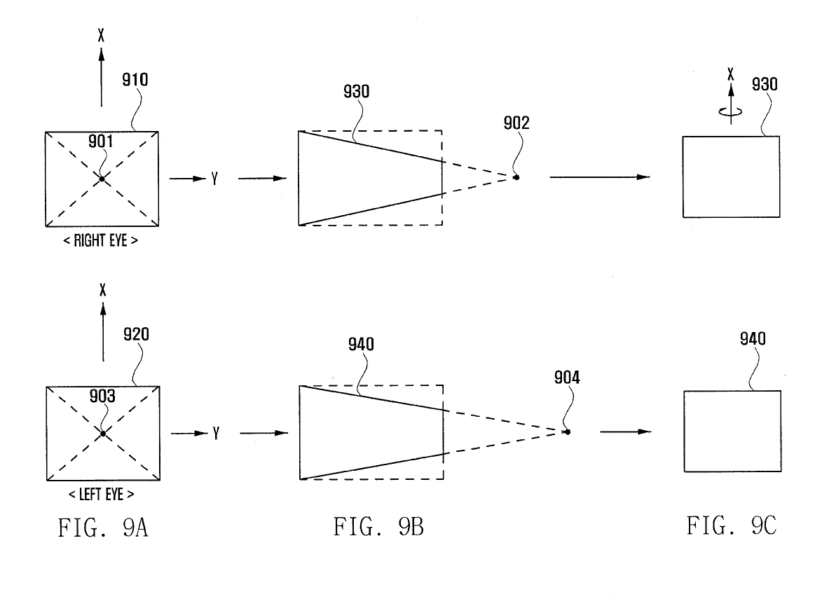

FIGS. 9A-9C are views according to another exemplary embodiment of the present invention.

Referring to FIGS. 9A-9C, the apparatus moves a vanishing point of a right eye image 910 from a center 901 to a location 902 distant along a Y axis in a right direction by a predetermined distance. In the same manner, the apparatus moves a vanishing point of the left eye image 920 from the center 903 to a location 904 distant along a Y axis in a right direction by a predetermined distance. The apparatus sets a changed amount of the vanishing point of left/right images in consideration of a binocular parallax. The apparatus transforms left/right eye images 910 and 920 based on respective changed amounts of the vanishing point. When the monitor 810 is rotated in a clockwise direction around the X axis, the transformed left/right eye images 930 and 940 are viewed similar to the original image in a certain horizontal rotation angle.

Hereinafter, a method and an apparatus for displaying an image implementing the foregoing embodiments are described below. It will be apparent that the apparatus for displaying an image according to an exemplary embodiment of the present invention may be, or may be incorporated in, any of various information and communication devices, such as a notebook PC, a desktop PC, a tablet PC, a smart phone, a High Definition Television (HDTV), a smart TV, a 3D TV, and an Internet Protocol Television (IPTV), and applications thereof.

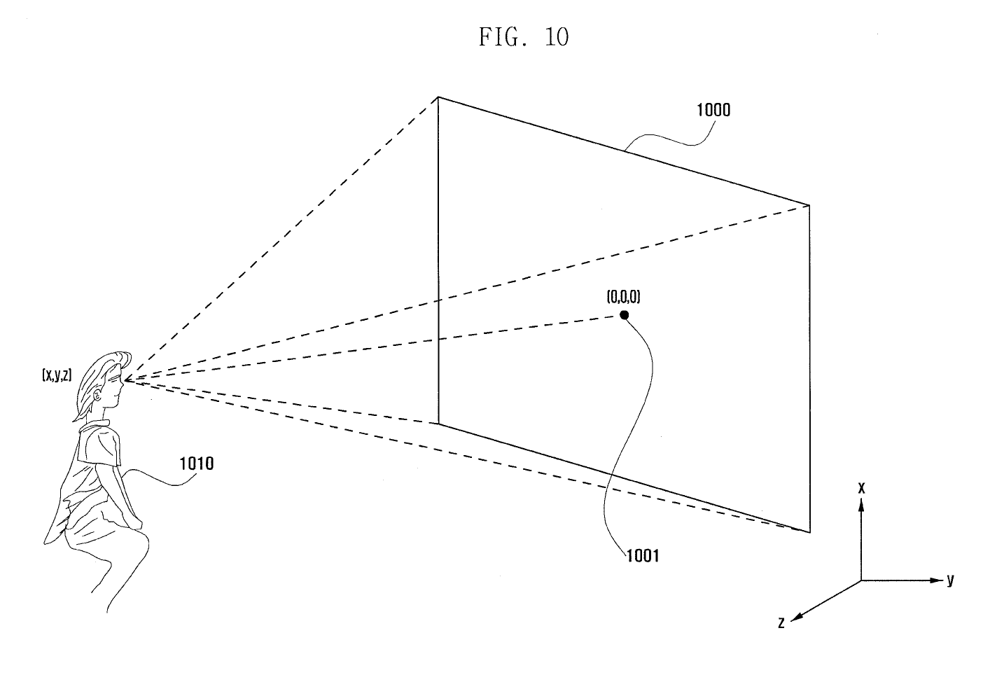

FIG. 10 is a three-dimensional coordinate system for expressing a location of a user according to an exemplary embodiment of the present invention.

Referring to FIG. 10, a center 1001 of a monitor 1000 may be set as center coordinates of a three-dimensional coordinate system. An upward direction in the center 1001 may be a positive direction of an X axis and a downward direction may be a negative direction of the X axis. A right direction may be a positive direction of a Y axis and a left direction may be a negative direction of the Y axis in the center 1001. Further, a direction from the center 1001 toward the user 1010 may be a positive direction of a Z axis and an opposite direction thereof may be a negative direction of a Z axis. Accordingly, a location of the user 1010 may be expressed by three-dimensional coordinates of (x, y, z).

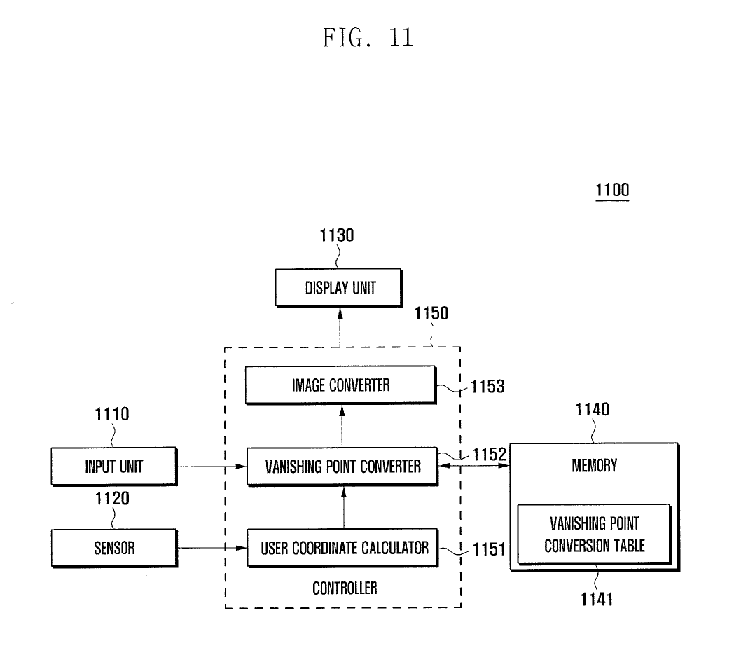

FIG. 11 is a block diagram illustrating an apparatus for displaying an image according to an exemplary embodiment of the present invention.

Referring to FIG. 11, an apparatus 1100 for displaying an image according to an exemplary embodiment of the present invention may include an input unit 1110, a sensor 1120, a display unit 1130, a memory 1140, and a controller 1150. The apparatus may include other units not shown herein for the sake of clarity, such as a communication unit. Similarly, the functionality of two or more of the above units may be integrated into a single component. For example, the input unit 1110 may be integrated with the display unit 1130 as a touch-sensitive display unit.

The input unit 1110 may include a key input part and/or a touch screen. The key input part is configured by a plurality of keys for operating the apparatus 1100 for displaying an image and transfers a key signal to the controller 1150. The touch screen creates and transfers a touch event to a controller 150.

The sensor 1120 may sense information associated with user location capable of tracking a location of the user 1010, and transfer the sensed information to the controller 1150. The sensor 1120 may be implemented by an image sensor or an optical sensor sensing light of certain wavelength such as infrared rays. The sensor 1120 converts a sensed physical amount into an electric signal, and an Analog to Digital (AD) converter converts the electric signal into sensing data, and transfers the sensing data to the controller 1150.

The display unit 1130 converts image data input from the controller 1150 into an analog signal, and displays the analog signal. The display unit 1130 may be an LCD, OLED or AMOLED.

The memory 1140 stores programs and data necessary for an operation of the apparatus for displaying an image. The memory 1140 stores a vanishing point conversion table 1141 in which a changed amount of a vanishing point matches a location value of the user 1010. The vanishing point conversion table 1141 may be received through a network or created by the controller 1150.

The controller 1150 controls an overall operation of the apparatus 1100 for displaying an image and signal flow between internal blocks of the apparatus 1100. The controller 1150 may include a user coordinate calculator 1151, a vanishing point converter 1152, and an image converter 1153.

The user coordinate calculator 1151 calculates a location value, i.e., three-dimensional coordinates (x, y, z) of the user using sensing information from the sensor 1120. The user coordinate calculator 1151 detects characteristic information of the user, for example, faces or eyes, to determine a detected face or a center point of the eye as coordinates of the user. An approach for determining coordinates of the user by detecting a face or an eyeball is a known image processing technology, and thus a detailed description thereof is omitted.

The vanishing point converter 1152 receives coordinates of the user from the user coordinate calculator 1151. The vanishing point calculator 1152 may receive a location value of the user from the input unit 1110. The user may directly input a location of the user in the apparatus for displaying an image through the input unit 1110. The input value may be three-dimensional coordinates or a certain location, for example, up/down/left/right. The vanishing point converter 1152 determines whether the user is located in front of the monitor based on a received location value. For example, if absolute values of x and y exceed preset values, the vanishing point converter 1152 recognizes that the user is not located in front of the monitor. Accordingly, the vanishing point converter 1152 confirms a changed amount of the vanishing point matching a location of the user from the vanishing point conversion table 1141. The vanishing point converter 1152 moves a vanishing point (x0, y0) of an original image by the confirmed changed amount (Δx, Δy) of the vanishing point.

The image converter 1153 transforms an original image based on the moved vanishing point (x0+Δx, y0+Δy) and transfers the transformed image to the display unit 1130. The original image may be a certain image of displayed screens. The image converter 1153 eliminates a background from the original image. The image converter 1153 extracts a certain part or image portion, for example, a man, from the image from which the background is eliminated. The image converter 1153 may transform the extracted certain part based on the moved vanishing point, combine the extracted certain part with a background, and transfer the combined result to the display unit 1130.

In some cases, the user may remain in substantially the same position even though the user's location has been determined to have changed. A location may be changed to some degree due to errors of a sensor and recognition. Accordingly, if the original image is transformed based on this change in the location, the user may feel inconvenience. Accordingly, a minimum location changed amount of the user for moving the vanishing point may be previously set. The minimum location changed amount may be an option which the user can directly set. The vanishing converter 1152 compares a current coordinate input from the user coordinate calculator 1151 with a previously input coordinate. The vanishing pointer converter 1152 may move the vanishing point only when a difference between the current input coordinate and the previously input coordinate exceeds the minimum location changed amount.

Although not shown, the controller 1150 may further include a table generator. The table generator moves a vanishing point of the original image to a predetermined location along a Y axis, and transforms and outputs the original image based on the moved vanishing point to the display unit 1130. The user rotates the display unit 1130 around the X axis in a predetermined direction, and inputs a key value in the input unit 1110 when an image displayed on the display unit 1130 is viewed similar to the original image. When a matching event corresponding to the key value is received from the input unit 1110, the table generator may match a changed amount of a vanishing point moved along a Y axis with a coordinate received from the user coordinate calculator 1151. Further, the table generator may create the vanishing point conversion table using the two matched values and transfer the generated table to the memory 1140.

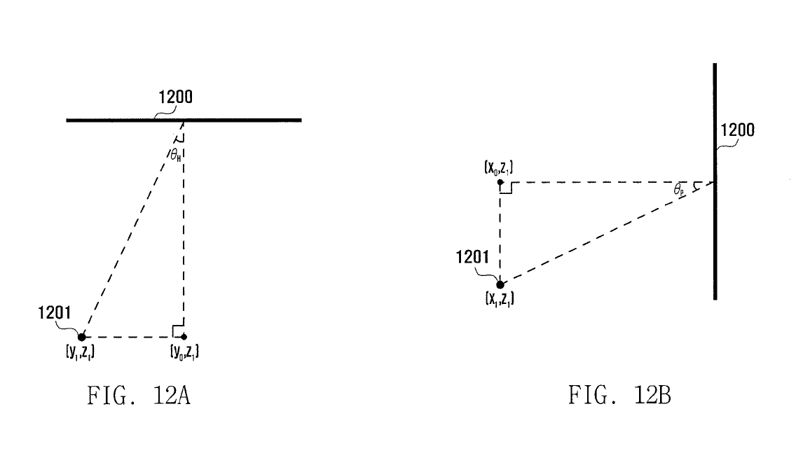

FIGS. 12A and 12B are views illustrating an angle system for expressing a viewing angle of the user according to an exemplary embodiment of the present invention.

Referring to FIGS. 12A and 12B, the apparatus 1100 applies a calculated coordinate (x1, y1, z1) of the user to a trigonometric function to calculate a horizontal viewing angle θH and a vertical viewing angle θP. The apparatus 1100 transforms an original image using the calculated viewing angles θH and θP.

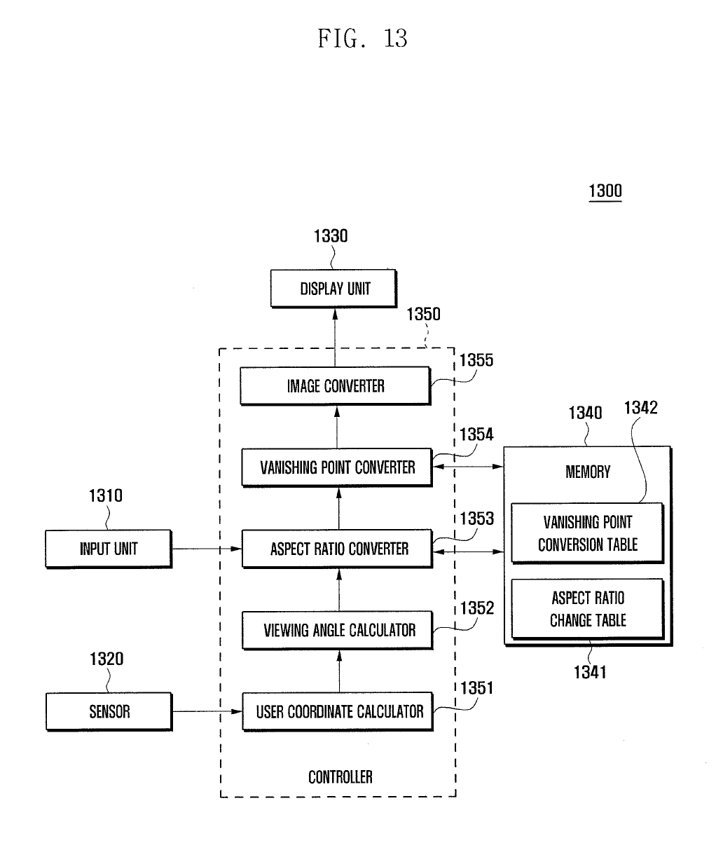

FIG. 13 is a block diagram illustrating an apparatus for displaying an image according to an exemplary embodiment of the present invention.

Referring to FIG. 13, an apparatus 1300 for displaying an image according to an exemplary embodiment of the present invention may include an input unit 1310, a sensor 1320, a display unit 1330, a memory 1340, and a controller 1350. The input unit 1310, sensor 1320, and display unit 1330 have similar constructions as the input unit 1110, sensor 1120, and display unit 1130, and accordingly a description of these units is omitted.

The memory 1340 stores an aspect ratio conversion table 1341 in which an aspect ratio changed amount matches a viewing angle and a vanishing point conversion table 1342 in which a vanishing point changed amount matches the viewing angle.

The controller 1350 may include a user coordinate calculator 1351, a viewing angle calculator 1352, an aspect ratio converter 1353, a vanishing point converter 1354, and an image converter 1355. The controller 1350 may also include a generator for generating an aspect ratio and a vanishing point conversion table.

The viewing angle calculator 1352 calculates viewing angles θH and θP using coordinates of the user received from the user coordinate calculator 1351. The aspect ratio converter 1353 may receive a viewing angle from the viewing angle calculator 1352 or the input unit 1310. The user may directly input the viewing angle through the input unit 1310. If absolute values of the viewing angles θH and θP exceed a preset value, the aspect ratio converter 1353 may recognize that the user is not located in front of the monitor. Accordingly, the aspect ratio converter 1353 confirms an aspect ratio changed value matching the received viewing angle from a corresponding table 1341, transforms an original image based on the confirmed aspect ratio changed amount, and transfers a viewing angle and the transformed image to the vanishing point converter 1354.

The vanishing point converter 1354 confirms a vanishing point changed amount matching the viewing angle from a corresponding table 1342, and moves a vanishing point of a transformed image by the confirmed vanishing point changed amount. The image converter 1355 again transforms the image based on the moved vanishing point and transfers the transformed image to the display unit 1330. A minimum viewing angle changed amount for converting an aspect ratio and a vanishing point.

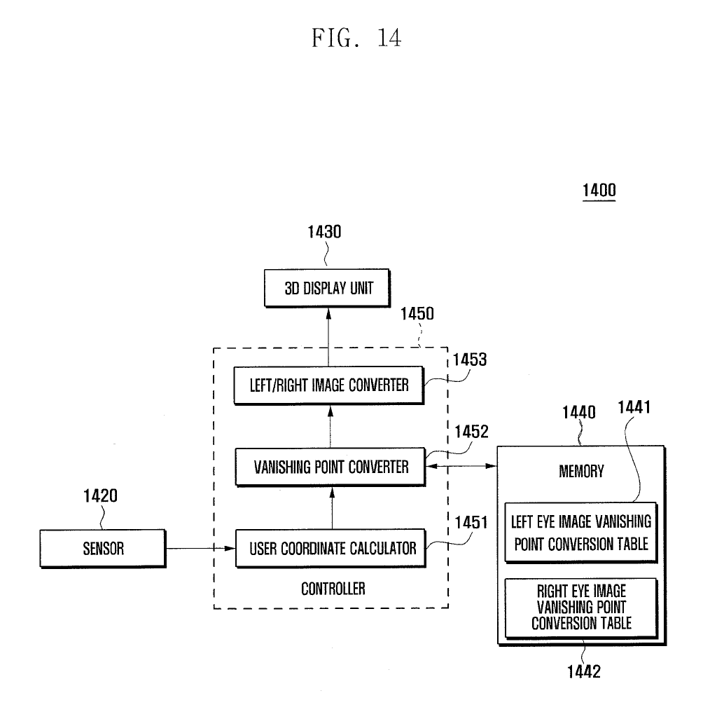

FIG. 14 is a block diagram illustrating an apparatus for displaying an image according to a further exemplary embodiment of the present invention.

Referring to FIG. 14, an apparatus 1400 for displaying an image according to an exemplary embodiment of the present invention may include a sensor 1420, a 3D display unit 1430, a memory 1440, and a controller 1405. The sensor 1420 may have a similar construction as the sensors 1120 and 1320, and thus a description of the sensor 1420 is omitted.

The 3D display unit 1430 includes a display part for displaying a left eye image and a right eye image and a 3D implementing part for controlling such that the user feels a depth feeling for displayed left/right eye images. The 3D implementing part may be arranged on the display part. The 3D implementing part controls such that left and right eyes of the user recognize a left eye image and a right eye image. As is known in the related art, 3D implementation technologies are divided into a glasses type and an auto-stereoscopic type. The glasses type includes a color filter type, a deflection filter type, and a shutter glass type. and the auto-stereoscopic type includes a lenticular lens type and a parallax barrier type. Because 3D implementation is a known technology, and exemplary embodiments of the present invention may implement any 3D implementation, a detailed description thereof is omitted.

The memory 1440 stores a left eye image vanishing point conversion table 1441 in which a changed amount of a vanishing point for a left eye image matches a location of the user and a right eye image vanishing point conversion table 1442 in which a changed amount of a vanishing point for a right eye image matches the location of the user.

The controller 1450 includes a user coordinator calculator 1451, a vanishing point converter 1452, and a left/right image converter 1453. The vanishing point converter 1452 receives a user location from the user coordinate calculator 1451. The vanishing point converter 1452 confirms vanishing point changed amounts of left/right eye images matching received coordinates of the user from corresponding tables 1441 and 1442, respectively. The vanishing point converter 1452 moves a vanishing point of a left image by a corresponding confirmed changed amount of the vanishing point and a vanishing point of a right image by a corresponding confirmed changed amount of the vanishing point. The left/right eye image converter 1453 transforms left/right eye images based on the moved vanishing points and transfers the transformed left/right images to a 3D display unit 1430.

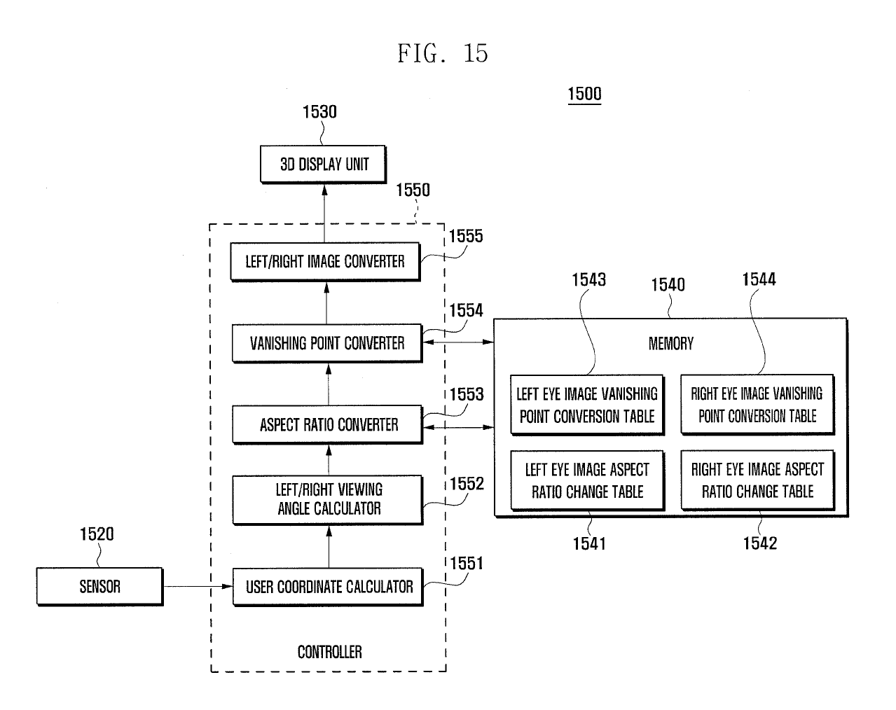

FIG. 15 is a block diagram illustrating an apparatus for displaying an image according to an exemplary embodiment of the present invention.

Referring to FIG. 15, an apparatus 1500 for displaying an image according to an exemplary embodiment of the present invention includes a sensor 1520, a 3D display unit 1530, a memory 1540, and a controller 1550. The memory 1540 includes a left eye image aspect ratio change table 1541, a right eye image aspect ratio change table 1542, a left eye image vanishing point conversion table 1543, and a right image vanishing point conversion table 1544. The controller 1550 includes a user coordinate calculator 1551, a left/right eye viewing angle calculator 1552, an aspect ratio converter 1553, a vanishing point converter 1554, and a left/right eye image converter 1555. The apparatus 1500 is a combination of the apparatus 1300 described with reference to FIG. 13 and the apparatus 1400 described with reference to FIG. 14, and thus a detailed description thereof is omitted.

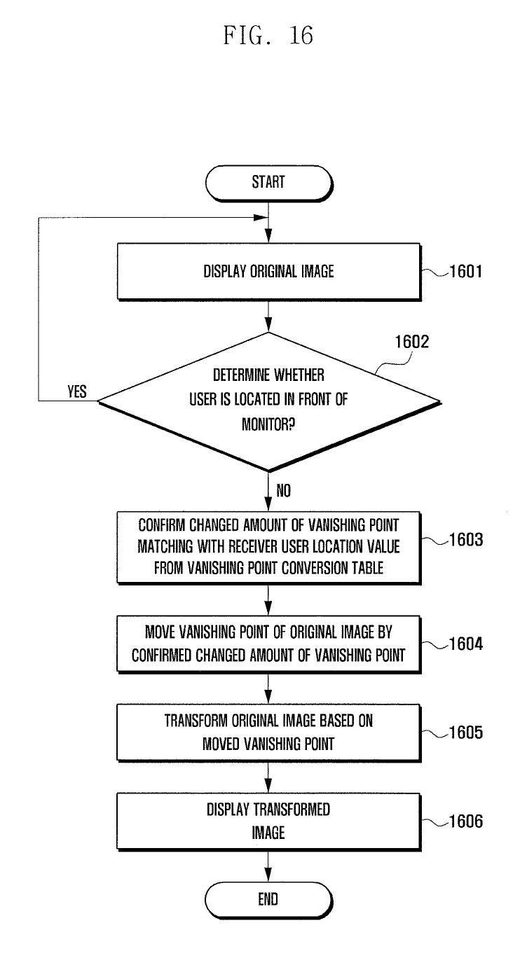

FIG. 16 is a flowchart illustrating a method for displaying an image according to an exemplary embodiment of the present invention.

Referring to FIG. 11 and FIG. 16, the display unit 1130 displays an original image in step 1601. The vanishing point converter 1152 determines whether a user is located in front of a monitor in step 1602. When the user is not located in front of a display unit, the vanishing point converter 1152 confirms a changed amount of a vanishing point matching a receiver user location value from a vanishing point conversion table 1141 in step 1603. The vanishing point converter 1153 moves a vanishing point of the original image by the confirmed changed amount of a vanishing point in step 1604. The image converter 1153 transforms the original image based on the moved vanishing point and transfers the transformed image to the display unit 1130 in step 1605. The display unit 1130 displays the transformed image in step 1606.

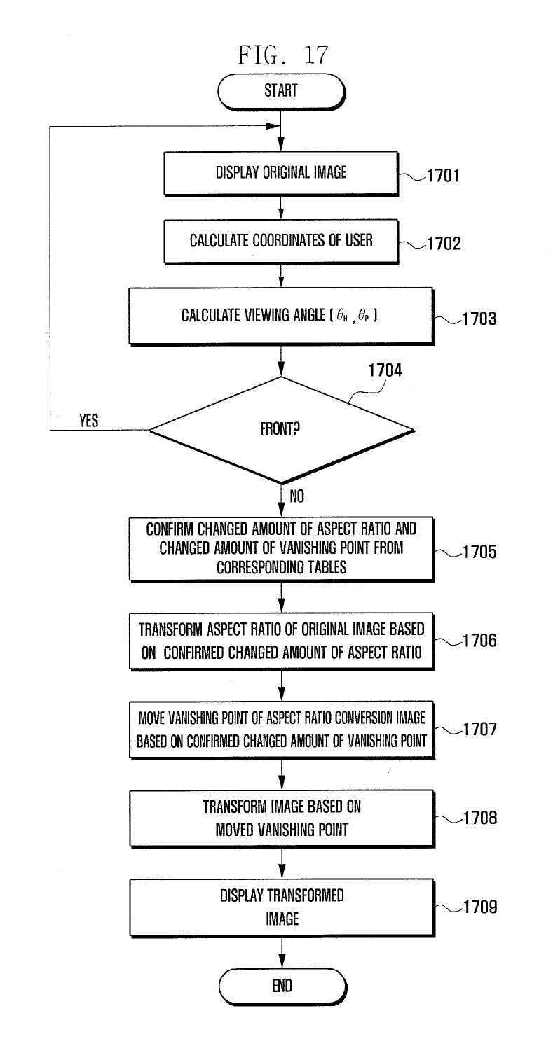

FIG. 17 is a flowchart illustrating a method for displaying an image according to an exemplary embodiment of the present invention.

Referring to FIG. 13 and FIG. 17, the display unit 1330 displays an original image in step 1701. The user location calculator 1351 calculates a location value, i.e., coordinates of a user, and transfers the calculated value of the user to a viewing angle calculator 1352 in step 1702. The viewing angle calculator 1352 calculates a viewing angle using received coordinates of the user and transfers the calculated viewing angle to the aspect ratio converter 1353 in step 1703. The aspect ratio converter 1353 determines whether the user is located in front of a display unit in step 1704. If the user is not located in front of a display unit, the aspect ratio converter 1353 and the vanishing point converter 1354 confirm a changed amount of an aspect ratio and a changed amount of a vanishing point from corresponding tables 1341 and 1342, respectively, in step 1705. The aspect ratio converter 1353 transforms an aspect ratio of an original image based on the confirmed changed amount of the aspect ratio in step 1706. The vanishing point converter 1354 moves a vanishing point of an aspect ratio conversion image based on the confirmed changed amount of the vanishing point in step 1707. The image converter 1355 transforms an image based on the moved vanishing point and transfers the transformed image to the display unit 1330 in step 1708. The display unit 1330 displays the transformed image in step 1709.

According to exemplary embodiments of the present invention, the user views an original image in a front surface in any location by compensating for a difference of a depth feeling according to the user location.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for displaying an image, the method comprising:
receiving a location value indicating a location of a user while displaying an original image;
transforming the original image based on the received location value; and
displaying the transformed image.

2. The method of claim 1, wherein the transforming of the original image comprises:
confirming a changed amount of a vanishing point matching the received location value from a vanishing point conversion table;
moving a vanishing point of the original image based on the confirmed changed amount of the vanishing point; and
transforming the original image based on the moved vanishing point.

3. The method of claim 1, wherein the location value comprises at least one of coordinates in which the user is located and a viewing angle of the user with a screen.

4. The method of claim 1, further comprising changing an aspect ratio of the original image before transforming the original image.

5. The method of claim 4, wherein the changing of the aspect ratio of the original image comprises:
increasing a transverse length of the original image or reducing a vertical length of the original image corresponding to an angle in which the original image is rotated based on a transverse axis; and
increasing the vertical length of the original image or reducing the transverse length of the original image corresponding to an angle in which the original image is rotated based on a vertical axis.

6. The method of claim 1, further comprising:
calculating a viewing angle of the user with a screen based on the received location value;
confirming a changed amount of an aspect ratio matching the calculated viewing angle from an aspect ratio conversion table; and
changing an aspect ratio of the original image based on the confirmed changed amount of the aspect ratio before transforming the original image.

7. The method of claim 1, wherein the transforming of the original image comprises transforming only a certain part of the original image.

8. The method of claim 7, wherein the transforming of the original image comprises:
eliminating a background from the original image;
extracting an image portion from the image from which the background is eliminated; and
transforming the extracted image portion.

9. An apparatus for displaying an image, the apparatus comprising:
a sensor for sensing information associated with a location of a user;
a controller for calculating a location value identifying the location of the user based on the sensing information received from the sensor, and for transforming the original image based on the calculated location value; and
a display unit for displaying the transformed image received from the controller.

10. The apparatus of claim 1, further comprising:
a memory for storing a vanishing point conversion table,
wherein the controller includes:
a vanishing point converter for confirming a changed amount of a vanishing point matching the received location value from a vanishing point conversion table, and for moving a vanishing point of the original image by the confirmed changed amount of the vanishing point, and
an image converter for transforming the original image based on the moved vanishing point.

11. The apparatus of claim 9, wherein the location value comprises at least one of coordinates in which the user is located and a viewing angle of the user with a screen.

12. The apparatus of claim 9, wherein the controller changes an aspect ratio of the original image and then transforms the original image corresponding to the calculated location value.

13. The apparatus of claim 12, wherein the controller increases a transverse length of the original image or reduces a vertical length of the original image corresponding to an angle in which the original image is rotated based on a transverse axis, and increases the vertical length of the original image or reduces the transverse length of the original image corresponding to an angle in which the original image is rotated based on a vertical axis.

14. The apparatus of claim 9, further comprising an input unit for receiving and transferring information associated with the location of the user to the controller.

15. The apparatus of claim 9, further comprising:
a memory for storing an aspect ratio change table and a vanishing point conversion table,
wherein the controller includes:
a viewing angle calculator calculating a viewing angle of the user with a screen based on the calculated location value,
an aspect ratio converter for confirming a changed amount of an aspect ratio matching the calculated viewing angle from the aspect ratio conversion table, and for changing an aspect ratio of the original image based on the confirmed changed amount of the aspect ratio before transforming the original image,
a vanishing point converter for confirming a changed amount of a vanishing point matching the calculated viewing angle from the vanishing point conversion table, and for moving a vanishing point of the image in which the aspect ratio is changed by the confirmed changed amount of the vanishing point; and
an image converter transforming the image in which the aspect ratio is changed based on the moved vanishing point.

16. The apparatus of claim 9, further comprising:
a three-dimensional implementing part controlling such that a left eye image and a right eye image are recognized by left and right eyes of the user,
wherein the controller transforms the left eye image and the right eye image based on the calculated location value, and the display unit displays the transformed left eye image and right eye image.

17. The apparatus of claim 9, wherein the display unit is a 3D display unit for displaying a 3D image.

18. The apparatus of claim 17, further comprising:
a memory unit for storing a left eye image vanishing point conversion table and a right eye image vanishing point conversion table,
wherein the controller transforms the left eye image and the right eye image based on the calculated location value and the respective left eye image vanishing point conversion table and right eye image vanishing point conversion table, and
wherein the display unit displays the transformed left eye image and right eye image.

19. The apparatus of claim 10, wherein the controller generates the vanishing point conversion table by transforming an original image based on a changed amount of the vanishing point, receiving a matching event, determining a viewing angle of the user when the matching event is received, matching the viewing angle with the changed amount of the vanishing point, matching the viewing angles with changed amounts of another vanishing point based on the two matched values, updating the vanishing point conversion table based on the results of the matching, and
wherein controller stores the updated vanishing point conversion table in the memory.

20. A method for displaying an image, the method comprising:
displaying an original image;
calculating a location and viewing angle of a user viewing the image;
determining whether the user is located in front of the monitor such that the original image would not appear distorted to the user, based on the calculated location and viewing angle; and
when the user is not located in front of the monitor such that the original image would appear distorted to the user, identifying a changed amount of a vanishing point based on the calculated location and viewing angle, moving the vanishing point of the original image based on the changed amount, transforming the image based on the moved vanishing point, and displaying the transformed image.
